(19) United States
(12) Patent Application Publication
(10) Pub. No.: US 2008/0111506 A1
(43) Pub. Date: May 15, 2008

(54) Vehicle, driving system, and control methods of the same

(76) Inventors: Koichiro Muta, Okazaki-shi (JP); Tomokazu Nomura, Anjo-shi (JP)

Correspondence Address: KENYON & KENYON LLP, 1500 K STREET N.W., SUITE 700, WASHINGTON, DC, 20005, US

(21) Appl. No.: 11/976,013

(22) Filed: Oct. 19, 2007

(30) Foreign Application Priority Data
Nov. 15, 2006 (JP) 2006-308999

(51) Int. Cl. G06F 19/00; H02H 7/08

(52) U.S. Cl. 318/15; 701/115

(57) ABSTRACT

The drive control of the invention changes an engagement status of relevant clutch and brake corresponding to a target gear speed n* of a transmission to half engagement while controlling a motor to output a torque corresponding to a torque demand Td* and the target gear speed n* (steps S190 and S210), when satisfaction of conditions that the absolute value of a rotation speed Nm of the motor is not greater than a preset reference value Nref and that the torque demand Td* is not lower than a preset reference torque Tref has continued for a preset reference time (steps S140 to S160).

### BACKGROUND

1. Technical Field

The present invention relates to a vehicle, a driving system mounted on a vehicle, and control methods of the vehicle and the driving system.

2. Related Art

One proposed technique applied to a vehicle lowers the level of driving current supplied to a driving motor to reduce output of the motor and move the vehicle back, when the vehicle is on an steep slope and falls in a stall state where the driving motor does not rotate regardless of supply of a certain motor-driving current to the motor (see, for example, Patent Document 1). The backward movement of the vehicle in the stall state rotates the motor and changes the phase of the phase current of the motor, so as to prevent overheat of the motor and an inverter circuit for driving the motor.
Patent Document 1: Japanese Patent Laid-Open Gazette No. 2001-177905

### SUMMARY

It is desired in the vehicle to prevent overheat of the motor and the inverter circuit in the stall state. There is an equivalent requirement in a vehicle equipped with a transmission mechanism, such as a clutch, between the driving motor and drive wheels.

In a vehicle equipped with a motor and a power transmission structure that enables and prohibits transmission of power between a power shaft linked with the motor and a driveshaft linked with drive wheels, a driving system mounted on a vehicle, and control methods of the vehicle and the driving system, there is a demand of preventing overheat of the motor and a driving circuit for driving the motor.

At least part of the above and the other related demands is attained by a vehicle, a driving system mounted on a vehicle, and control methods of the vehicle and the driving system of the invention having the configurations discussed below.

According to one aspect, the present invention is directed to a vehicle including: a motor that outputs a driving force to a power shaft; a power transmission structure that enables and prohibits transmission of power between the power shaft and a driveshaft linked with drive wheels; and a control module that, when the motor satisfies a rotation stop output condition to output the driving force in a rotation stop state of a rotor in the motor, controls the power transmission structure to make a driving force transmittable by the power transmission structure smaller than the driving force output to the power shaft.

When the motor outputting power to the power shaft satisfies the rotation stop output condition to output the driving force in the rotation stop state of the rotor in the motor, the vehicle of the invention controls the power transmission structure, which enables and prohibits transmission of power between the power shaft and the driveshaft linked with drive wheels, to make the driving force transmittable by the power transmission structure smaller than the driving force output to the power shaft. Such control rotates a rotating shaft of the motor and changes the phase of a phase current flowing in the motor, so as to effectively prevent overheat of the motor and a driving circuit for driving the motor.

In one application of the vehicle of the invention, the control module regards a state of continued output of the driving force from the motor in the rotation stop state of the rotor in the motor for a preset time period as satisfaction of the rotation stop output condition and controls the power transmission structure. This arrangement adequately identifies satisfaction or dissatisfaction of the rotation stop output condition.

In another application of the vehicle of the invention, the vehicle further has a temperature measurement unit that measures either of a temperature of the motor and a temperature of a driving circuit that drives the motor. The control module may regard a state of an increase in measured temperature over a preset reference temperature during output of the driving force from the motor in the rotation stop state of the rotor in the motor as satisfaction of the rotation stop output condition and controls the power transmission structure. This arrangement effectively restricts the frequency of the control on the assumption of satisfaction of the rotation stop output condition. The preset reference temperature may be a slightly lower temperature than an allowable temperature of the motor or the driving circuit.

In still another application of the vehicle of the invention, the control module controls the motor to rotate the rotor by at least a minimum rotation quantity that causes a phase current level of the motor to be different from a phase current in the rotation stop state of the rotor. This arrangement more effectively prevents overheat of the motor and the driving circuit for driving the motor. The control module may control the motor to decrease the phase current of or over a predetermined current level to a preset range including a value ‘0’. The predetermined current level is out of the preset range.

In another application of the vehicle of the invention, the control module controls the motor to keep an output driving force level ensuring output of a required driving force to the driveshaft. This arrangement effectively prevents the vehicle from sliding down in the course of the control under satisfaction of the rotation stop output condition.

In another application of the vehicle of the invention, the power transmission structure has at least one clutch and changes an engagement status of the clutch to enable and prohibit the transmission of power between the power shaft and the driveshaft. In still another application of the vehicle of the invention, the power transmission structure utilizes a pressure of an operating fluid to enable and prohibit the transmission of power between the power shaft and the driveshaft. Further, the power transmission structure enables and prohibits the transmission of power between the power shaft and the driveshaft with a change of a gear speed.

In one application of the invention, the vehicle further includes: an internal combustion engine; and a rotation adjustment assembly that is connected to an output shaft of the internal combustion engine and to the power shaft rotatable independently of the output shaft and adjusts a rotation speed of the output shaft relative to the power shaft with input and output of electric power and input and output of a driving force to and from the output shaft and the power shaft.

According to another aspect, the present invention is directed to a driving system mounted on a vehicle. The driving system includes: a motor that outputs a driving force to a power shaft; a power transmission structure that enables and prohibits transmission of power between the power shaft and a driveshaft linked with drive wheels; and a control module that, when the motor satisfies a rotation stop output condition to output the driving force in a rotation stop state of a rotor in the motor, controls the power transmission structure to make a driving force transmittable by the power transmission structure smaller than the driving force output to the power shaft.

When the motor outputting power to the power shaft satisfies the rotation stop output condition to output the driving force in the rotation stop state of the rotor in the motor, the driving system of the invention controls the power transmission structure, which enables and prohibits transmission of power between the power shaft and the driveshaft linked with drive wheels, to make the driving force transmittable by the power transmission structure smaller than the driving force output to the power shaft. Such control rotates a rotating shaft of the motor and changes the phase of a phase current flowing in the motor, so as to effectively prevent overheat of the motor and a driving circuit for driving the motor.

According to still another aspect, the present invention is directed to a control method of a vehicle equipped with a motor that outputs a driving force to a power shaft and a power transmission structure that enables and prohibits transmission of power between the power shaft and a driveshaft linked with drive wheels. When the motor satisfies a rotation stop output condition to output the driving force in a rotation stop state of a rotor in the motor, the control method of the vehicle of the invention controls the power transmission structure to make a driving force transmittable by the power transmission structure smaller than the driving force output to the power shaft.

When the motor outputting power to the power shaft satisfies the rotation stop output condition to output the driving force in the rotation stop state of the rotor in the motor, the control method of the vehicle of the invention controls the power transmission structure, which enables and prohibits transmission of power between the power shaft and the driveshaft linked with drive wheels, to make the driving force transmittable by the power transmission structure smaller than the driving force output to the power shaft. Such control rotates a rotating shaft of the motor and changes the phase of a phase current flowing in the motor, so as to effectively prevent overheat of the motor and a driving circuit for driving the motor.

According to another aspect, the present invention is directed to a control method of a driving system, which is mounted on a vehicle and includes a motor that outputs a driving force to a power shaft and a power transmission structure that enables and prohibits transmission of power between the power shaft and a driveshaft linked with drive wheels. When the motor satisfies a rotation stop output condition to output the driving force in a rotation stop state of a rotor in the motor, the control method of the driving system of the invention controls the power transmission structure to make a driving force transmittable by the power transmission structure smaller than the driving force output to the power shaft.

When the motor outputting power to the power shaft satisfies the rotation stop output condition to output the driving force in the rotation stop state of the rotor in the motor, the control method of the driving system of the invention controls the power transmission structure, which enables and prohibits transmission of power between the power shaft and the driveshaft linked with drive wheels, to make the driving force transmittable by the power transmission structure smaller than the driving force output to the power shaft. Such control rotates a rotating shaft of the motor and changes the phase of a phase current flowing in the motor, so as to effectively prevent overheat of the motor and a driving circuit for driving the motor.

### BRIEF DESCRIPTION OF THE DRAWINGS

FIG. 1 schematically illustrates the configuration of an electric vehicle in one embodiment of the invention;

FIG. 2 shows the schematic structure of an electric drive system including a motor in the electric vehicle of the embodiment;

FIG. 3 shows the schematic structure of a transmission mounted on the electric vehicle of the embodiment;

FIG. 4 is a flowchart showing a drive control routine executed by an electronic control unit mounted on the electric vehicle of the embodiment;

FIG. 5 shows one example of a torque demand setting map;

FIG. 6 schematically illustrates the configuration of an electric vehicle in one modified example; and

FIG. 7 schematically illustrates the configuration of another electric vehicle in another modified example.

### DESCRIPTION OF THE PREFERRED EMBODIMENTS

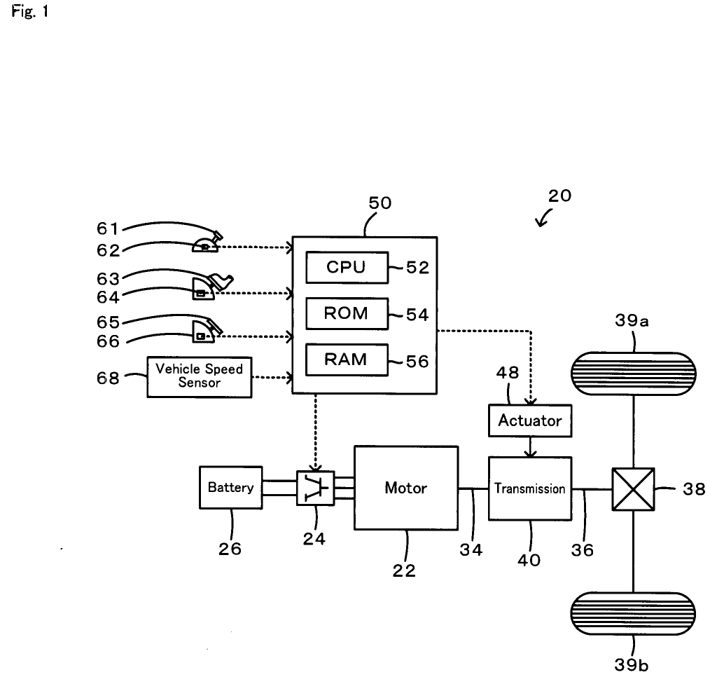

One mode of carrying out the invention is described below as a preferred embodiment with reference to the accompanied drawings. FIG. 1 schematically illustrates the configuration of an electric vehicle 20 in one embodiment of the invention. As illustrated, the electric vehicle 20 of the embodiment includes a motor 22 that outputs power to a power shaft 34, an inverter 24 that utilizes electric power supplied from a battery 26 to drive the motor 22, a transmission 40 that transmits the output power from the power shaft 34 to a driveshaft 36 linked with drive wheels 39a and 39b via a differential gear 38, and an electronic control unit 50 that controls the operations of the whole electric vehicle 20.

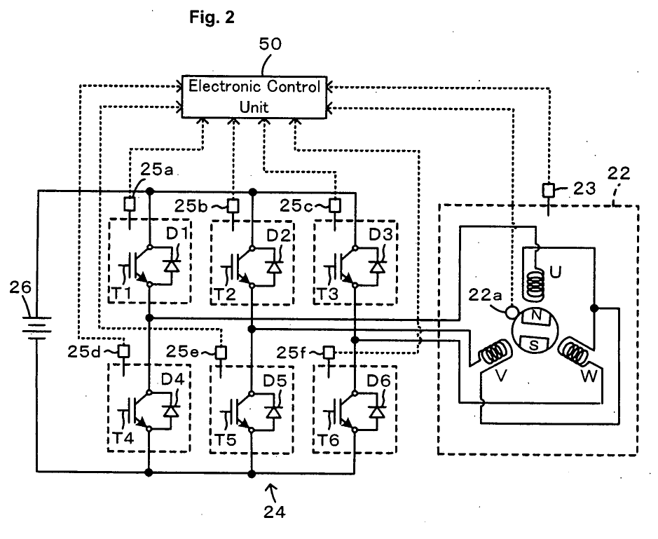

FIG. 2 shows the schematic structure of an electric drive system including the motor 22 in the electric vehicle 20 of the embodiment. As illustrated, the motor 22 has a rotor with permanent magnets attached thereto and a stator with three phase coils wound thereon. The motor 22 is constructed as a known synchronous motor generator that may be actuated both as a generator and as a motor. The inverter 24 includes six transistors T1 to T6 and six diodes D1 to D6 connected in inverse parallel with the transistors T1 to T6. The six transistors T1 to T6 are arranged in pairs to function as the source and the sink to a positive bus connecting with a cathode of the battery 26 and to a negative bus connecting with an anode of the battery 26. Three phase coils (U phase, V phase, and W phase) of the motor 22 are connected to the connection points of the respective pairs of transistors T1 to T6. Regulation of the ratio of ON time of the respective pairs of the transistors T1 to T6 forms a rotating magnetic field in the three phase coils to drive and rotate the motor 22.

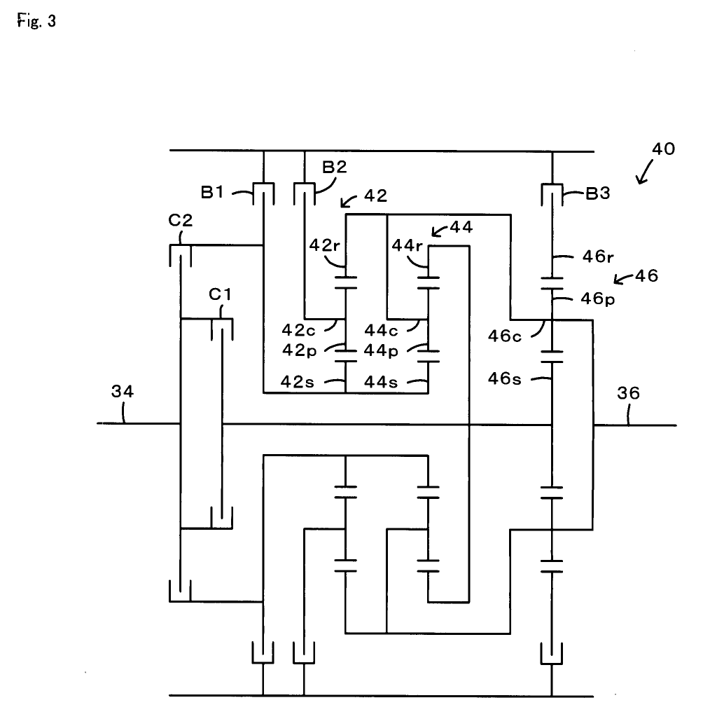

The transmission 40 is constructed to connect the power shaft 34 with the driveshaft 36 for transmission of power between the power shaft 34 and the driveshaft 36 with a change of the speed and to disconnect the power shaft 34 from the driveshaft 36. One example of the structure of the transmission 40 is shown in FIG. 3. The transmission 40 of FIG. 3 has single-pinion planetary gear mechanisms 42, 44, and 46, two clutches C1 and C2, and three brakes B1, B2, and B3. The planetary gear mechanism 42 includes a sun gear 42s as an external gear, a ring gear 42r as an internal gear arranged concentrically with the sun gear 42s, multiple pinion gears 42p engaging with the sun gear 42s and with the ring gear 42r, and a carrier 42c holding the multiple pinion gears 42p to allow both their revolutions and their rotations on their axes. The sun gear 42s is connected to and is disconnected from the power shaft 34 by engagement and release of the clutch C2. Engagement and release of the brake B1 stop and allow the rotation of the sun gear 42s, while engagement and release of the brake B2 stop and allow the rotation of the carrier 42c. The planetary gear mechanism 44 includes a sun gear 44s as an external gear, a ring gear 44r as an internal gear arranged concentrically with the sun gear 44s, multiple pinion gears 44p engaging with the sun gear 44s and with the ring gear 44r, and a carrier 44c holding the multiple pinion gears 44p to allow both their revolutions and their rotations on their axes. The sun gear 44s is linked to the sun gear 42s of the planetary gear mechanism 42. The ring gear 44r is connected to and is disconnected from the power shaft 34 by engagement and release of the clutch C1. The carrier 44c is linked to the ring gear 42r of the planetary gear mechanism 42. The planetary gear mechanism 46 includes a sun gear 46s as an external gear, a ring gear 46r as an internal gear arranged concentrically with the sun gear 46s, multiple pinion gears 46p engaging with the sun gear 46s and with the ring gear 46r, and a carrier 46c holding the multiple pinion gears 46p to allow both their revolutions and their rotations on their axes. The sun gear 46s is linked to the ring gear 44r of the planetary gear mechanism 44. Engagement and release of the brake B3 stop and allow the rotation of the ring gear 46r. The carrier 46c is linked to the ring gear 42r of the planetary gear mechanism 42, to the carrier 44c of the planetary gear mechanism 44, and to the driveshaft 36. In the transmission 40, the release of all the clutches C1 and C2 and the brakes B1, B2, and B3 disconnects the power shaft 34 from the driveshaft 36. The engagement of the clutch C1 and the brake B3 in combination with the release of the clutch C2 and the brakes B1 and B2 reduces the rotation of the power shaft 34 at a relatively high reduction ratio and transmits the reduced rotation to the driveshaft 36. Hereafter this state is referred to as the ‘first speed’. The engagement of the clutch C1 and the brake B2 in combination with the release of the clutch C2 and the brakes B1 and B3 reduces the rotation of the power shaft 34 at a lower reduction ratio than that in the first speed and transmits the reduced rotation to the driveshaft 36. Hereafter this state is referred to as the ‘second speed’. The engagement of the clutch C1 and the brake B1 in combination with the release of the clutch C2 and the brakes B2 and B3 reduces the rotation of the power shaft 34 at a lower reduction ratio than that in the second speed and transmits the reduced rotation to the driveshaft 36. Hereafter this state is referred to as the ‘third speed’. The engagement of the clutches C1 and C2 in combination with the release of the brakes B1, B2, and B3 directly transmits the rotation of the power shaft 34 to the driveshaft 36 without speed reduction. Hereafter this state is referred to as the ‘fourth speed’. In the transmission 40, the engagement of the clutch C2 and the brake B3 in combination with the release of the clutch C1 and the brakes B1 and B2 reverses and reduces the rotation of the power shaft 34 and transmits the reversed and reduced rotation to the driveshaft 36. Hereafter this state is referred to as the ‘reverse speed’. In the structure of this embodiment, as shown in FIG. 1, a hydraulic actuator 48 is driven to regulate the hydraulic pressures applied to the clutches C1 and C2 and the brakes B1, B2, and B3 and thereby control the engagement and the release of the clutches C1 and C2 and the brakes B1, B2, and B3.

The electronic control unit 50 is constructed as a microprocessor including a CPU 52, a ROM 54 that stores processing programs, a RAM 56 that temporarily stores data, and input and output ports (not shown). The electronic control unit 50 receives, via its input port, a gearshift position SP from a gearshift position sensor 62 that detects a current setting position of a gearshift lever 61, an accelerator opening Acc from an accelerator pedal position sensor 64 that measures a driver's depression amount of an accelerator pedal 63, a brake pedal position BP from a brake pedal position sensor 66 that measures the driver's depression amount of a brake pedal 65, a vehicle speed V from a vehicle speed sensor 68, a rotational position of the rotor of the motor 22 from a rotational position detection sensor 22a, a motor temperature ‘tm’ of the motor 22 from a temperature sensor 23, element temperatures ‘ta’ to ‘tf’ of the transistors T1 to T6 included in the inverter 24 from temperature sensors 25a to 25f, and phase currents flowing through the respective phases in the three phase coils of the motor 22 from current sensors (not shown). The electronic control unit 50 outputs, via its output port, switching control signals to the respective transistors T1 to T6 in the inverter 24 and driving signals to the actuator 48 for the transmission 40.

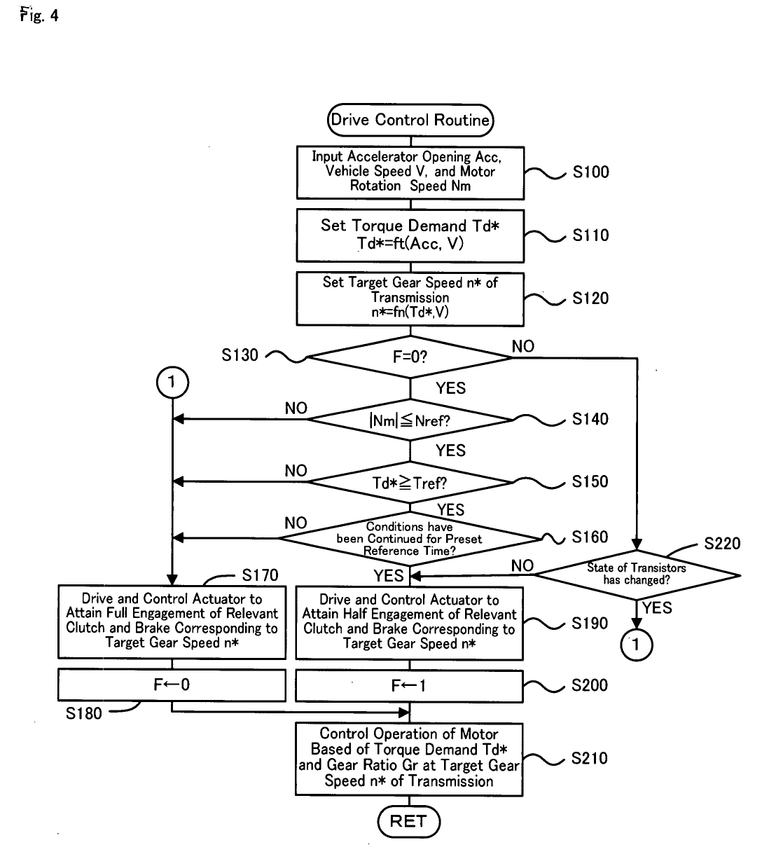

The description regards the operations of the electric vehicle 20 of the embodiment having the configuration discussed above, especially a series of operation control when the electric vehicle 20 stops on an upslope in the state of the driver's depression of the accelerator pedal 63. FIG. 4 is a flowchart showing a drive control routine executed by the electronic control unit 50. This drive control routine is performed repeatedly at preset time intervals, for example, at every several msec.

In the drive control routine, the CPU 52 of the electronic control unit 50 first inputs various data required for control, that is, the accelerator opening Acc from the accelerator pedal position sensor 64, the vehicle speed V from the vehicle speed sensor 68, and a rotation speed Nm of the motor 22 (step S100). The rotation speed Nm of the motor 22 is calculated from the rotational position of the rotor of the motor 22 detected by the rotational position detection sensor 22a according to a motor rotation speed calculation routine (not shown) and is written at a predetermined address in the RAM 54. The CPU 52 reads the calculated rotation speed Nm of the motor 22 from the predetermined address in the RAM 54 at step S100.

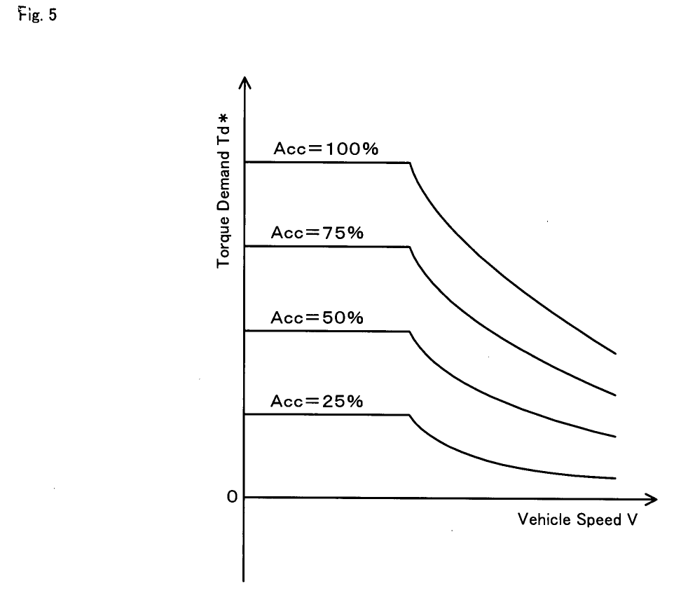

After the data input, the CPU 52 sets a torque demand Td* to be output to the driveshaft 36 linked with the drive wheels 39a and 39b as a torque required for the electric vehicle 20, based on the input accelerator opening Acc and the input vehicle speed V (step S110). The CPU 52 subsequently sets a target gear speed n* of the transmission 40, based on the torque demand Td* and the vehicle speed V (step S120). A concrete procedure of setting the torque demand Td* in this embodiment stores in advance variations in torque demand Td* against the accelerator opening Acc and the vehicle speed V as a torque demand setting map in the ROM 54 and reads the torque demand Td* corresponding to the given accelerator opening Acc and the given vehicle speed V from this torque demand setting map. One example of the torque demand setting map is shown in FIG. 5. A concrete procedure of setting the target gear speed n* of the transmission 40 in this embodiment stores in advance variations in target gear speed n* against the torque demand Td* and the vehicle speed V as a target gear speed setting map (not shown) in the ROM 54 and reads the target gear speed n* corresponding to the given torque demand Td* and the given vehicle speed V from this target gear speed setting map. When the electric vehicle 20 stops on an upslope in the state of the driver's depression of the accelerator pedal 63, the first speed is set to the target gear speed n* of the transmission 40.

The CPU 52 then identifies the value of a flag F (step S130). The flag F is set to 0 for full engagement of relevant clutch and brake corresponding to the current setting of the target gear speed n* among the clutches C1 and C2 and the brakes B1, B2, and B3 in the transmission 40, while being set to 1 for half engagement of the relevant clutch and brake.

When the flag F is equal to 0 (step S130: yes), the CPU 52 successively compares the absolute value of the rotation speed Nm of the motor 22 with a preset reference value Nref (step S140) and the torque demand Td* with a preset reference torque Tref (step S150). When the absolute value of the rotation speed Nm of the motor 22 is not greater than the preset reference value (step S140: yes) and when the torque demand Td* is not lower than the preset reference torque Tref (step S150: yes), it is determined whether these conditions has continued for a preset reference time (step S160). The reference value Nref is a criterion used for identifying a substantial rotation stop state of the motor 22 and depends upon the characteristics of the motor 22 and the inverter 24. The reference torque Tref is a criterion used for detecting output of a certain level of torque from the motor 22 and depends upon the characteristics of the motor 22. The reference time is set as a criterion for identifying the substantial rotation stop state of the motor 22 and detecting the output of the certain level of torque from the motor 22. It is here assumed that the electric vehicle 20 stops (the rotor of the motor 22 stops rotation) on an upslope in the state of the driver's depression of the accelerator pedal 63. For output of a relatively large torque from the motor 22 in spite of the rotation stop of its rotor, a large electric current is flowed through only a specific phase in the three phase coils of the motor 22. This may lead to an excessive temperature increase of only a specific transistor among the transistors T1 to T6 of the inverter 24. The driver's drastic depression of the accelerator pedal 63 for a start of the electric vehicle 20 on a flat road may also cause the absolute value of the rotation speed Nm of the motor 22 to be not greater than the preset reference value Nref and the torque demand Td* to be not lower than the preset reference torque Tref. In such a case, however, these conditions continue only for a relatively short time. It is thus unlikely to cause an excessive temperature increase of the specific transistor. The processing of steps S140 to S160 identifies estimation of an excessive temperature increase of the specific transistor among the transistors T1 to T6 of the inverter 24.

When the absolute value of the rotation speed Nm of the motor 22 is greater than the preset reference value Nref (step S140: no), when the torque demand Td* is lower than the preset reference torque Tref (step S150: no), or when satisfaction of the conditions that the absolute value of the rotation speed Nm is not greater than the preset reference value Nref and that the torque demand Td* is not lower than the preset reference torque Tref has not yet continued for the preset reference time (steps S140 and S150: yes, step S160: no), the CPU 52 drives and controls the actuator 48 to attain full engagement of the relevant clutch and brake corresponding to the target gear speed n* among the clutches C1 and C2 and the brakes B1, B2, and B3 in the transmission 40 (step S170). For example, when the target gear speed n* is set to the first speed, the actuator 48 is driven and controlled to attain full engagement of the clutch C1 and the brake B3. The CPU 52 subsequently sets the flag F to 0 (step S180) and performs switching control of the transistors T1 to T6 included in the inverter 24 to ensure output of a torque Td*/Gr, which is division of the torque demand Td* by a gear ratio Gr at the target gear speed n* of the transmission 40, from the motor 22 (step S210). The drive control routine of FIG. 4 is then terminated. In this case, the motor 22 outputs a torque equivalent to the torque demand Td* to the drive wheels 39a and 39b in the fully engaged condition of the relevant clutch and brake corresponding to the target gear speed n* of the transmission 40.

When satisfaction of the conditions that the absolute value of the rotation speed Nm of the motor 22 is not greater than the preset reference value Nref and that the torque demand Td* is not lower than the preset reference torque Tref has continued for the preset reference time (steps S140 to S160: yes), it is likely to cause an excessive temperature increase of the specific transistor among the transistors T1 to T6 of the inverter 24. The CPU 52 drives and controls the actuator 48 to attain half engagement of the relevant clutch and brake corresponding to the target gear speed n* among the clutches C1 and C2 and the brakes B1, B2, and B3 in the transmission 40 (step S190). For example, when the target gear speed n* is set to the first speed, the actuator 48 is driven and controlled to attain half engagement of the clutch C1 and the brake B3. The CPU 52 subsequently sets the flag F to 1 (step S200) and performs switching control of the transistors T1 to T6 included in the inverter 24 to ensure output of the torque Td*/Gr from the motor 22 (step S210). The drive control routine of FIG. 4 is then terminated. In this case, the relevant clutch and brake corresponding to the target gear speed n* of the transmission 40 is half engaged to prevent transmission of part of output torque from the motor 22 to the driveshaft 36. The half engagement of the relevant clutch and brake corresponding to the target gear speed n* makes a transmittable torque level by the transmission 40 smaller than the output torque from the motor 22. The motor 22 rotates its rotor in this half engagement status.

When the flag F is equal to 1 (step S130: no), on the other hand, the CPU 52 identifies whether there is a change in the state of the transistors T1 to T6 in the inverter 24 for the motor 22 (step S220). The change in the state of the transistors T1 to T6 causes the flow of different phase currents in the three phase coils of the motor 22. For example, the identification of step S220 may be based on the determination of whether the current flowing through a certain phase in the three phase coils of the motor 22 decreases from a relatively large value to a predetermined relatively small range including the value ‘0’. The identification of step S220 may be based on the determination of whether the rotational position of the rotor in the motor 22 is shifted by at least a rotational angle corresponding to an electrical angle of 2π/3. The electrical angle of 2π/3 is equivalent to one phase of the phase current of the motor 22. When there is no change in the state of the transistors T1 to T6 (step S220: no), the CPU 52 estimates the flow of substantially identical phase currents in the three phase coils of the motor 22. The CPU 52 then executes the processing of and after step S190 and exits from the drive control routine of FIG. 4. When there is a change in the state of the transistors T1 to T6 (step S220: yes), on the other hand, the CPU 52 estimates the flow of different phase currents in the three phase coils of the motor 22. The CPU 52 drives and controls the actuator 48 to change the engagement status of the relevant clutch and brake corresponding to the target gear speed n* from the half engagement to the full engagement (step S170), sets the flag F to 0 (step S180), and performs switching control of the transistors T1 to T6 in the inverter 24 to ensure output of the torque Td*/Gr from the motor 22 (step S210). The drive control routine of FIG. 4 is then terminated.

It is here assumed that the electric vehicle 20 stops on an upslope (the rotor of the motor 22 stops its rotation) in the state of the driver's depression of the accelerator pedal 63 for the preset reference time. Under such conditions, there may be an excessive temperature increase in a certain phase of the three phase coils of the motor 22 or in a specific transistor among the transistors T1 to T6 of the inverter 24. In response to estimation of an excessive temperature increase, the engagement status of the relevant clutch and brake corresponding to the target gear speed n* of the transmission 40 is changed from the full engagement to the half engagement with output of the torque Td*/Gr from the motor 22. The half engagement makes the motor 22 rotate and shifts the rotational position of its rotor to vary the phase currents flowing in the respective phases of the three phase coils of the motor 22. Such control effectively prevents an excessive temperature increase in the certain phase of the three phase coils of the motor 22 or in the specific transistor among the transistors T1 to T6 of the inverter 24. The gear speed of the transmission 40 is generally set to the first speed in this state. The engagement status of at least either of the clutch C1 and the brake B3 is changed to the half engagement to rotate the motor 22.

In the electric vehicle 20 of the embodiment described above, when satisfaction of the conditions that the absolute value of the rotation speed Nm of the motor 22 is not greater than the preset reference value Nref and that the torque demand Td* is not lower than the preset reference torque Tref has continued for the preset reference time, the engagement status of the relevant clutch and brake corresponding to the target gear speed n* of the transmission 40 is changed to the half engagement with output of the torque Td*/Gr, which is based on the torque demand Td* and the target gear speed n*, from the motor 22. Such control rotates the motor 22 to change the phase of the phase current and effectively prevents an excessive temperature increase in the motor 22 and the inverter 24.

The electric vehicle 20 of the embodiment changes the engagement status of the relevant clutch and brake corresponding to the target gear speed n* of the transmission 40 to the half engagement, based on the rotation speed Nm of the motor 22 and the torque demand Td*. The rotation speed Nm of the motor 22 may be replaced by the vehicle speed V. The torque demand Td* may also be replaced by the operation status of the accelerator pedal 63 and the brake pedal 65. For example, the engagement status of the relevant clutch and brake corresponding to the target gear speed n* of the transmission 40 may be changed to the half engagement when the vehicle speed V at a substantially zero level and the accelerator-on and brake-off state have continued for a preset reference time.

In the electric vehicle 20 of the embodiment, when satisfaction of the conditions that the absolute value of the rotation speed Nm of the motor 22 is not greater than the preset reference value Nref and that the torque demand Td* is not lower than the preset reference torque Tref has continued for the preset reference time, the engagement status of the relevant clutch and brake corresponding to the target gear speed n* of the transmission 40 is changed to the half engagement, irrespective of the motor temperature ‘tm’ and an inverter temperature ‘tinv’. One possible modification may change the engagement status of the relevant clutch and brake corresponding to the target gear speed n* of the transmission 40 to the half engagement, in response to an increase in motor temperature ‘tm’ over a preset reference motor temperature ‘tmref’ or in response to an increase in inverter temperature ‘tinv’ over a preset reference inverter temperature ‘tinvref’. The inverter temperature ‘tinv’ may be the highest temperature among the element temperatures ‘ta’ to ‘tf’ measured by the temperature sensors 25a to 25f. The reference motor temperature ‘tmref’ and the reference inverter temperature ‘tinvref’ may be set to slightly lower temperatures than respective allowable temperatures of the motor 22 and of the inverter 24. Such modified control restricts the frequency of changing the engagement status of the relevant clutch and brake corresponding to the target gear speed n* of the transmission 40 to the half engagement.

The electric vehicle 20 of the embodiment controls the motor 22 to output the torque Td*/Gr while changing the engagement status of the relevant clutch and brake corresponding to the target gear speed n* of the transmission 40 to the half engagement. One possible modification may output a slightly greater torque than the torque Td*/Gr during the change of the engagement status. For example, the electric vehicle 20 of the embodiment may control the motor 22 to output a torque equivalent to the output torque level in the full engagement state to the driveshaft 36 linked with the drive wheels 39a and 39b during the change of the engagement status of the relevant clutch and brake corresponding to the target gear speed n* of the transmission 40 to the half engagement. Such modified control effectively prevents the electric vehicle 20 from sliding down during the change of the engagement status of the relevant clutch and brake corresponding to the target gear speed n* of the transmission 40 to the half engagement.

The electric vehicle 20 of the embodiment is equipped with the transmission 40 that enables transmission of power with a change of the speed between the power shaft 34 linked with the motor 22 and the driveshaft 36 linked with the drive wheels 39a and 39b. The transmission 40 is, however, not essential but may be replaced by a clutch or any other suitable mechanism having the function of adjusting the torque transmittable between the power shaft 34 and the driveshaft 36.

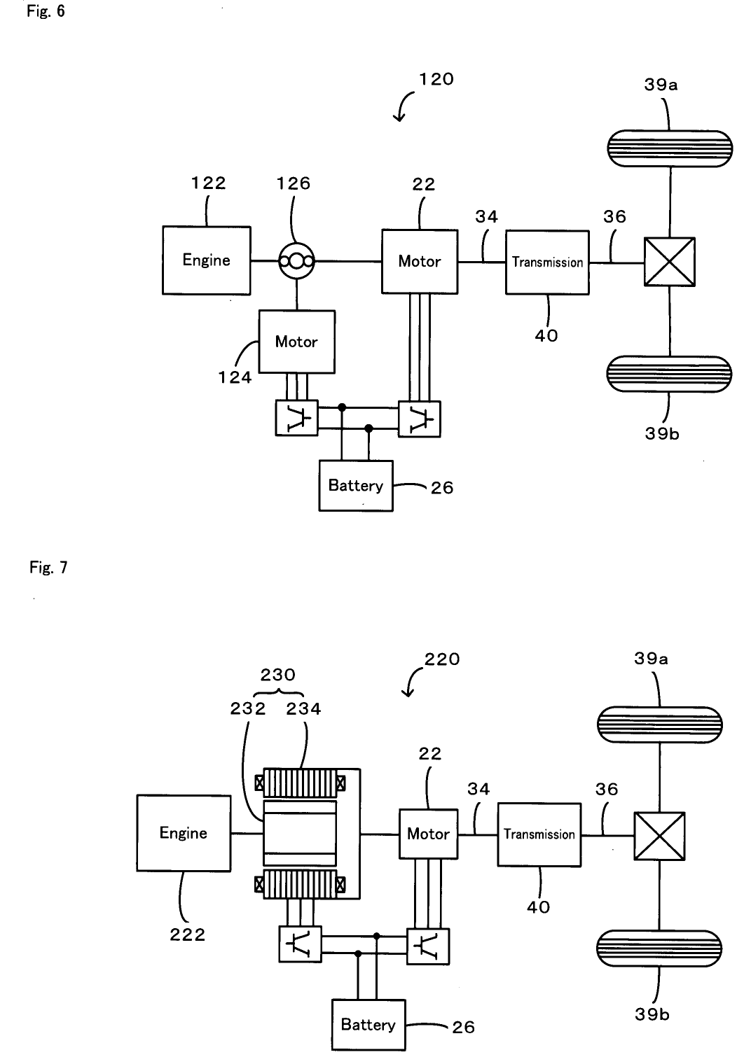

The embodiment regards the electric vehicle 20 equipped with the motor 22 that outputs power to the power shaft 34 connected to the driveshaft 36 via the transmission 40. The technique of the invention is also applicable to an electric vehicle 120 shown in FIG. 6 as one modified example. The electric vehicle 120 has an engine 122 and a motor 124 connected to a power shaft 34 via a planetary gear mechanism 126. The technique of the invention is further applicable to another electric vehicle 220 shown in FIG. 7 as another modified example. The electric vehicle 220 has an engine 222 and a pair-rotor motor 230, which includes an inner rotor 232 connected to a crankshaft of the engine 222 and an outer rotor 234 connected to a power shaft 34 linked with a driveshaft 36 via a transmission 40. The pair-rotor motor 230 transmits part of the output power of the engine 222 to the power shaft 34, while converting the residual engine output power into electric power.

The primary elements in the embodiment and its modified examples are mapped to the primary constituents in the claims of the invention as described below. The motor 22 outputting power to the power shaft 34 in the structure of the embodiment corresponds to the ‘motor’ of the invention. The transmission 40 that includes the clutches C1 and C2 and the brakes B1, B2, and B3 and is controlled to change the engagement status of the clutches C1 and C2 and the brakes B1, B2, and B3 by the operation control of the hydraulic actuator 48 and thereby enable connection of the power shaft 34 with the driveshaft 36 for transmission of power with a change of the speed between the power shaft 34 and the driveshaft 36 linked with the drive wheels 39a and 39b via the differential gear 38 and disconnection of the power shaft 34 from the driveshaft 36 in the structure of the embodiment is equivalent to the ‘power transmission structure’ of the invention. The electronic control unit 50 that executes the drive control routine of FIG. 3 in the structure of the embodiment is equivalent to the ‘control module’ of the invention. The drive control routine of FIG. 3 changes the engagement status of the relevant clutch and brake corresponding to the target gear speed n* of the transmission 40 to the half engagement while controlling the motor 22 to output the torque Td*/Gr corresponding to the torque demand Td* and the target gear speed n*, when satisfaction of the conditions that the absolute value of the rotation speed Nm of the motor 22 is not greater than the preset reference value Nref and that the torque demand Td* is not lower than the preset reference torque Tref has continued for the preset reference time. The temperature sensor 23 that measures the temperature ‘tm’ of the motor 22 and the temperature sensors 25a to 25f that measure the element temperatures ‘ta’ to ‘tf’ of the transistors T1 to T6 in the inverter 24 for driving the motor 22 in the structure of the embodiment are equivalent to the ‘temperature measurement unit’ of the invention. The clutch that transmits power between the power shaft 34 and the driveshaft 36 in the modified structure is equivalent to the ‘power transmission structure’ of the invention. The engine 122 in the structure of one modified example is equivalent to the ‘internal combustion engine’ of the invention. The planetary gear mechanism 126 linked with the power shaft 34 and the motor 124 connected with the planetary gear mechanism 126 in the structure of this modified example are equivalent to the ‘rotation adjustment assembly’ of the invention. The engine 222 in the structure of another modified example is also equivalent to the ‘internal combustion engine’ of the invention. The pair-rotor motor 230 that includes the inner rotor 232 connected to the crankshaft of the engine 222 and the outer rotor 234 connected to the power shaft 34 linked with the driveshaft 36 via the transmission 40 and transmits part of the output power of the engine 222 to the power shaft 34 while converting the residual engine output power into electric power in the structure of this modified example is also equivalent to the ‘rotation adjustment assembly’ of the invention. This mapping of the primary elements in the embodiment and its modified examples to the primary constituents in the claims of the invention are not restrictive in any sense but are only illustrative for concretely describing some modes of carrying out the invention. Namely the embodiment and its modified examples discussed above are to be considered in all aspects as illustrative and not restrictive. The scope and spirit of the present invention are indicated by the appended claims, rather than by the foregoing description.

The embodiment regards application of the invention to the electric vehicle. This application is, however, only illustrative and not restrictive in any sense. The technique of the invention may be actualized by diversity of other applications, for example, driving systems mounted on various vehicles including automobiles and other vehicles as well as control methods of such various vehicles and driving systems.

The embodiment and its modified examples discussed above are to be considered in all aspects as illustrative and not restrictive. There may be many other modifications, changes, and alterations without departing from the scope or spirit of the main characteristics of the present invention.

The disclose of Japanese Patent Application No. 2006-308999 filed Nov. 15, 2006 including specification, drawings and claims is incorporated herein by reference in its entirety.

What is claimed is:

1. A vehicle, comprising:
a motor that outputs a driving force to a power shaft;
a power transmission structure that enables and prohibits transmission of power between the power shaft and a driveshaft linked with drive wheels; and
a control module that, when the motor satisfies a rotation stop output condition to output the driving force in a rotation stop state of a rotor in the motor, controls the power transmission structure to make a driving force transmittable by the power transmission structure smaller than the driving force output to the power shaft.

2. The vehicle in accordance with claim 1, wherein the control module regards a state of continued output of the driving force from the motor in the rotation stop state of the rotor in the motor for a preset time period as satisfaction of the rotation stop output condition and controls the power transmission structure.

3. The vehicle in accordance with claim 1, the vehicle further having:
a temperature measurement unit that measures either of a temperature of the motor and a temperature of a driving circuit that drives the motor,
wherein the control module regards a state of an increase in measured temperature over a preset reference temperature during output of the driving force from the motor in the rotation stop state of the rotor in the motor as satisfaction of the rotation stop output condition and controls the power transmission structure.

4. The vehicle in accordance with claim 1, wherein the control module controls the motor to rotate the rotor by at least a minimum rotation quantity that causes a phase current level of the motor to be different from a phase current in the rotation stop state of the rotor.

5. The vehicle in accordance with claim 1, wherein the control module controls the motor to keep an output driving force level ensuring output of a required driving force to the driveshaft.

6. The vehicle in accordance with claim 1, wherein the power transmission structure has at least one clutch and changes an engagement status of the clutch to enable and prohibit the transmission of power between the power shaft and the driveshaft.

7. The vehicle in accordance with claim 1, wherein the power transmission structure utilizes a pressure of an operating fluid to enable and prohibit the transmission of power between the power shaft and the driveshaft.

8. The vehicle in accordance with claim 1, wherein the power transmission structure enables and prohibits the transmission of power between the power shaft and the driveshaft with a change of a gear speed.

9. The vehicle in accordance with claim 1, the vehicle further having:
an internal combustion engine; and
a rotation adjustment assembly that is connected to an output shaft of the internal combustion engine and to the power shaft rotatable independently of the output shaft and adjusts a rotation speed of the output shaft relative to the power shaft with input and output of electric power and input and output of a driving force to and from the output shaft and the power shaft.

10. A driving system mounted on a vehicle, the driving system comprising:
a motor that outputs a driving force to a power shaft;
a power transmission structure that enables and prohibits transmission of power between the power shaft and a driveshaft linked with drive wheels; and
a control module that, when the motor satisfies a rotation stop output condition to output the driving force in a rotation stop state of a rotor in the motor, controls the power transmission structure to make a driving force transmittable by the power transmission structure smaller than the driving force output to the power shaft.

11. A control method of a vehicle equipped with a motor that outputs a driving force to a power shaft and a power transmission structure that enables and prohibits transmission of power between the power shaft and a driveshaft linked with drive wheels,
when the motor satisfies a rotation stop output condition to output the driving force in a rotation stop state of a rotor in the motor, the control method controlling the power transmission structure to make a driving force transmittable by the power transmission structure smaller than the driving force output to the power shaft.

12. A control method of a driving system, the driving system being mounted on a vehicle and including a motor that outputs a driving force to a power shaft and a power transmission structure that enables and prohibits transmission of power between the power shaft and a driveshaft linked with drive wheels,
when the motor satisfies a rotation stop output condition to output the driving force in a rotation stop state of a rotor in the motor, the control method controlling the power transmission structure to make a driving force transmittable by the power transmission structure smaller than the driving force output to the power shaft.
